(19) United States
(12) Patent Application Publication
(10) Pub. No.: US 2024/0381250 A1
(43) Pub. Date: Nov. 14, 2024

(54) TRANSMISSION WINDOWS FOR PEER-TO-PEER COMMUNICATIONS

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/652,709

(22) Filed: May 1, 2024

Related U.S. Application Data
(60) Provisional application No. 63/466,049, filed on May 12, 2023.

(51) Int. Cl. H04W 52/02; H04W 92/18

(52) U.S. Cl. CPC H04W 52/0216; H04W 52/0206; H04W 92/18

(57) ABSTRACT

Methods and apparatuses for facilitating establishment and use of a time window that is conducive to transmission of unmanaged traffic in a wireless local area network (WLAN). A method performed by an access point (AP) comprises determining a schedule of one or more peer-to-peer (P2P) transmission windows that are time windows conducive to P2P transmissions by non-AP STAs in a basic service set (BSS) associated with the AP, transmitting, to the STAs in the BSS, a message including parameters for the schedule of P2P transmission windows and an indication that the STAs should perform P2P transmissions during the P2P transmission windows, and avoiding infrastructure communications during the P2P transmission windows.

### CROSS-REFERENCE TO RELATED APPLICATION AND CLAIM OF PRIORITY

This application claims priority under 35 U.S.C. § 119 (e) to U.S. Provisional Patent Application No. 63/466,049 filed on May 12, 2023, which is hereby incorporated by reference in its entirety.

### TECHNICAL FIELD

This disclosure relates generally to latency sensitive operations in wireless communications systems. Embodiments of this disclosure relate to methods and apparatuses that reduce interference between managed and unmanaged traffic in a wireless local area network communications system.

### BACKGROUND

Wireless local area network (WLAN) technology allows devices to access the internet in the 2.4 gigahertz (GHz), 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI (wireless fidelity) devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

Target wake time (TWT) is one of the most important features for power management in WI-FI networks, which was developed by IEEE 802.11ah and later adopted and modified into IEEE 802.11ax. TWT allows an AP to manage activity in the BSS (basic service set) to minimize contention between STAs and reduce the required amount of time that a STA utilizing a power management mode needs to be awake. This is achieved by allocating STAs to operate at nonoverlapping times and/or frequencies and concentrating the frame exchange sequences in predefined service periods. With TWT operation, it suffices for a STA to only wake up at a pre-scheduled time negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT service period (SP) is used to exchange frames with other STAs. Frames transmitted during a TWT SP are carried in any PPDU format supported by the pair of STAs that have established the TWT agreement corresponding to that TWT SP, including HE MU PPDU, HE TB PPDU, etc.

In IEEE 802.11 standards, two types of TWT operation are possible-individual TWT operation and broadcast TWT operation. Individual TWT agreements can be established between two STAs or between a STA and an AP. The negotiation that takes place for an individual TWT agreement between two STAs is on an individual basis. The AP can have TWT agreements with multiple STAs. Any changes in the TWT agreement between the AP and one STA do not affect the TWT agreement between the AP and the other STA.

IEEE 802.11ax first introduced the broadcast TWT (bTWT or B-TWT) operation. The broadcast TWT operates in a membership-based approach. With broadcast TWT operation, an AP can set up a shared TWT session for a group of STAs. The AP is typically the controller of the broadcast TWT schedule. The non-AP STAs in the BSS can request membership in the schedule, or the AP can send an unsolicited response to the STA to make the STA a member of the broadcast TWT schedule the AP maintains in the BSS. The AP can advertise/announce and maintain multiple broadcast TWT schedules in the network. When a change is made to any of the schedules in the network, it affects all the STAs that are members of that particular schedule.

### SUMMARY

Embodiments of the present disclosure provide methods and apparatuses that facilitate establishment and use of a time window that is conducive to transmission of unmanaged traffic in a WLAN.

In one embodiment, a method performed by an AP wireless device comprises determining a schedule of one or more peer-to-peer (P2P) transmission windows that are time windows conducive to P2P transmissions by non-AP STAs in a BSS associated with the AP, transmitting, to the STAs in the BSS, a message including parameters for the schedule of P2P transmission windows and an indication that the STAs should perform P2P transmissions during the P2P transmission windows, and avoiding infrastructure communications during the P2P transmission windows.

In another embodiment, a method performed by a non-AP STA wireless device comprises receiving, from an AP in a BSS with which the STA is associated, a message including parameters for a schedule of P2P transmission windows and an indication that the STA should perform P2P transmissions during the P2P transmission windows, wherein the AP avoids infrastructure communications during the P2P transmission windows, and performing P2P transmissions during the indicated P2P transmission windows.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example network architecture in which infrastructure traffic and non-infrastructure traffic coexist according to embodiments of the present disclosure;

FIG. 4 illustrates an example timing diagram of announcement of P2P transmission windows by an AP according to embodiments of the present disclosure;

FIG. 5 illustrates an example timing diagram for a scenario in which an AP indicates recommended channels for transmissions during P2P transmission windows and continues transmissions on other channels during the P2P transmission windows according to embodiments of the present disclosure;

FIG. 6 illustrates an example timing diagram for a scenario in which an AP aligns a power saving schedule with indicated P2P transmission windows according to embodiments of the present disclosure;

FIG. 7 illustrates an example process performed by an AP to devise and announce a schedule for P2P transmission windows according to embodiments of the present disclosure;

FIG. 8 illustrates an example process performed by a non-AP STA to follow a schedule for P2P transmission windows according to embodiments of the present disclosure; and

FIG. 9 illustrates an example process for facilitating establishment and use of a time window that is conducive to transmission of unmanaged traffic operations in a WLAN according to various embodiments of the present disclosure.

### DETAILED DESCRIPTION

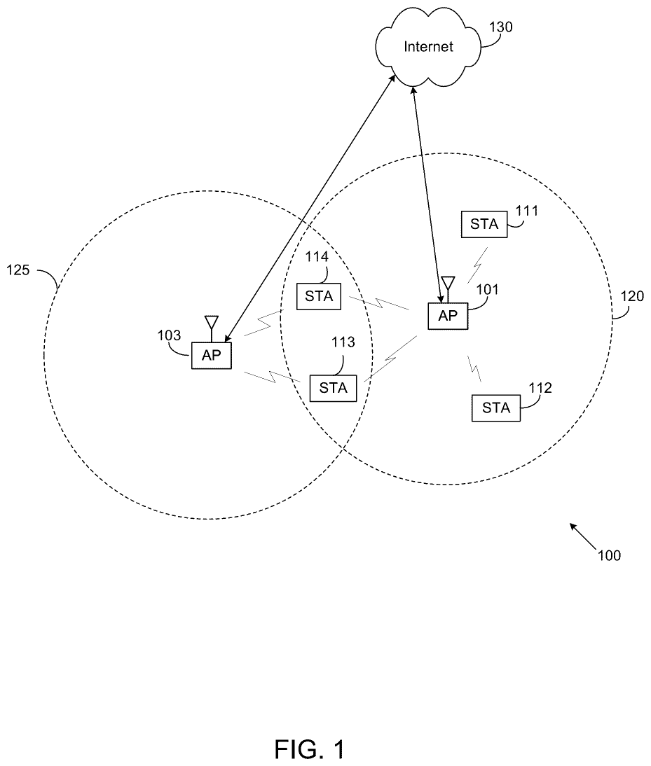

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that next generation WLAN systems will need to provide strong support for low-latency (i.e., latency-sensitive) applications. It is not uncommon to observe numerous devices operating on the same network (e.g., the same BSS). Many such devices may be latency-tolerant but still contend with devices with latency-sensitive applications for the same time and frequency resources in the BSS. In some cases, the AP as the network controller of an infrastructure BSS may not have enough control over unregulated (or unmanaged) traffic that contends with the latency-sensitive traffic within the infrastructure BSS. Some of the unmanaged traffic that interferes with the latency-sensitive traffic in the AP's BSS may come from uplink (UL)/downlink (DL) or direct link (e.g., peer-to-peer or P2P) communications within the infrastructure BSS that the AP manages (i.e., infrastructure traffic). Other unmanaged traffic interference may come from transmissions in a neighboring infrastructure BSS (an overlapping BSS, or OBSS). Yet other unmanaged traffic interference may come from neighboring independent BSSs or P2P networks.

Embodiments of the present disclosure thus recognize that next generation WLAN systems will need mechanisms to handle unmanaged traffic in order to prioritize the low-latency traffic in the network. For a WLAN network, if the STAs within the BSS or neighboring BSSs use pre-determined or recommended channels for uplink/downlink or direct link communications, this could significantly help to manage the traffic in the BSS, and thereby support latency-sensitive applications in the network. Accordingly, embodiments of the present disclosure provide methods and apparatuses that facilitate use of a transmission window dedicated for P2P communication that will help better manage P2P communication in the network.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

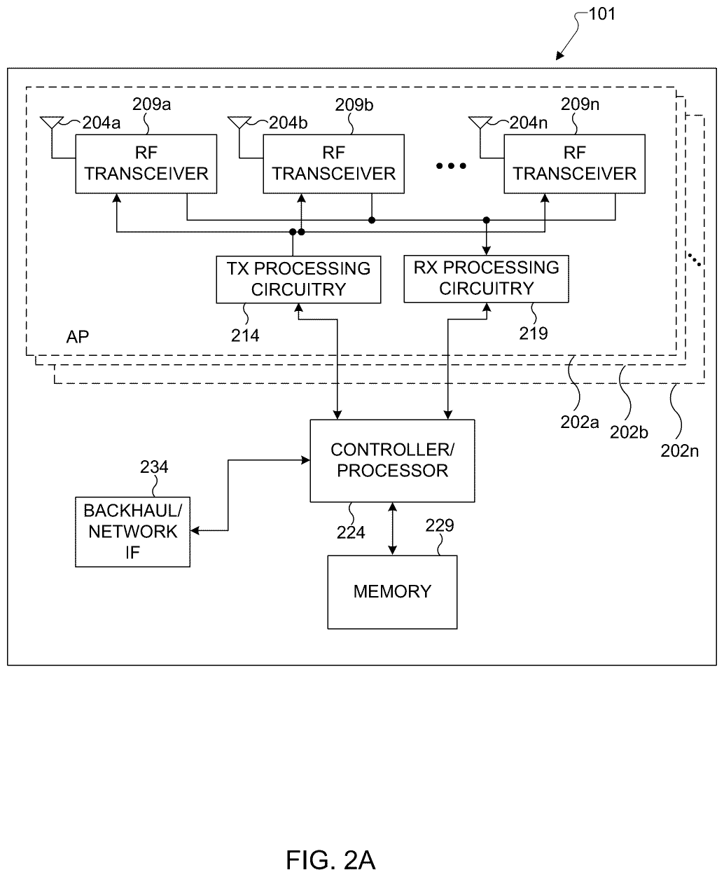

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). The controller/processor 224 could also facilitate establishment and use of a time window that is conducive to transmission of unmanaged traffic in a WLAN. Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as operations for facilitating establishment and use of a time window that is conducive to transmission of unmanaged traffic in a WLAN. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate establishment and use of a time window that is conducive to transmission of unmanaged traffic in a WLAN. In some embodiments, the controller/processor 240 includes at least one microprocessor or microcontroller.

The controller/processor 240 is also capable of executing other processes and programs resident in the memory 260, such as operations for facilitating establishment and use of a time window that is conducive to transmission of unmanaged traffic in a WLAN. The controller/processor 240 can move data into or out of the memory 260 as required by an executing process. In some embodiments, the controller/processor 240 is configured to execute a plurality of applications 262, such as applications for facilitating establishment and use of a time window that is conducive to transmission of unmanaged traffic in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

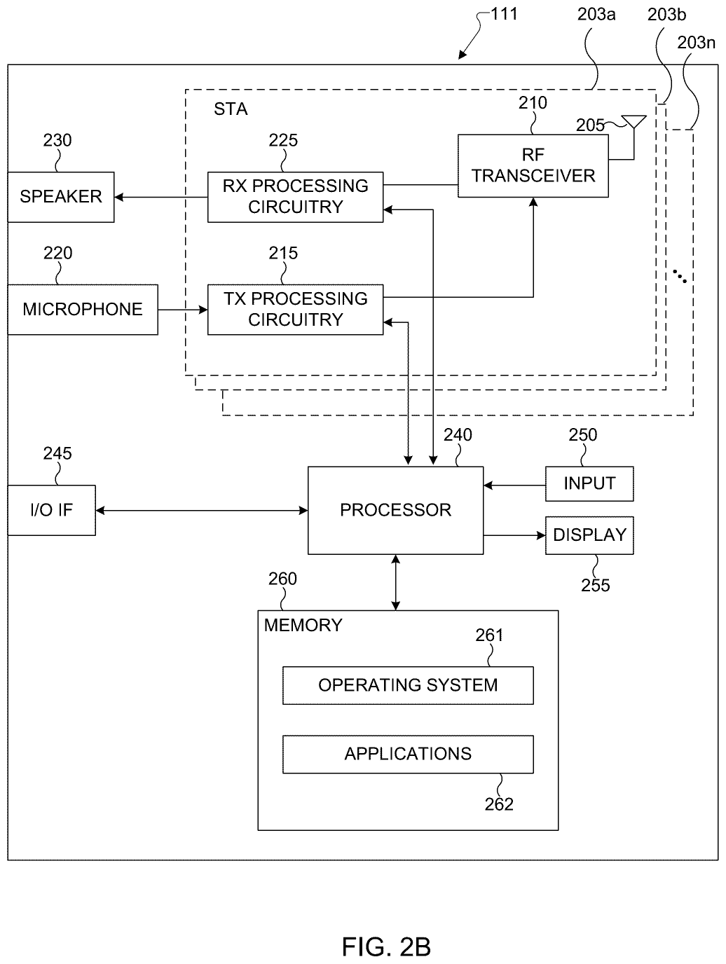

FIG. 3 illustrates an example network architecture 300 in which infrastructure traffic and non-infrastructure traffic coexist according to embodiments of the present disclosure. In the example of FIG. 3, the AP may be an AP 101, and each of the STAs may be a STA 111-114, although not all of the STAs are associated with the AP. The STAs that are not associated with the AP may belong to a neighboring independent BSS or P2P networks. It is understood that references to an AP herein below refer to an AP 101, and references to a non-AP STA refer to a STA 111-114.

As discussed above, various embodiments of the present disclosure provide methods and apparatuses that facilitate use of a transmission window dedicated for P2P communication that will help better manage P2P communication in the network. According to one embodiment, an AP can announce or advertise in its BSS a set of time windows that are conducive to P2P transmissions. Such time windows can be referred to as P2P transmission windows.

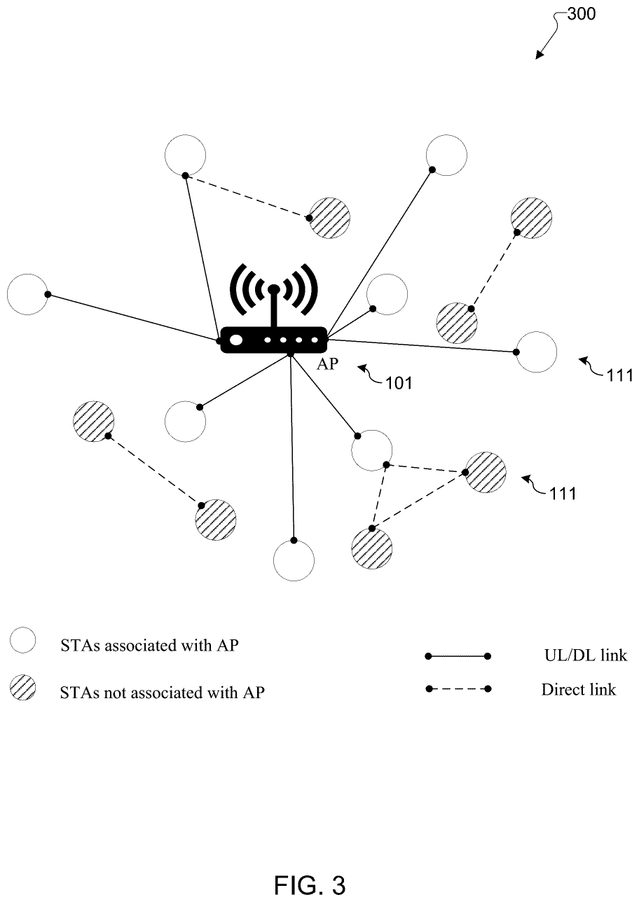

FIG. 4 illustrates an example timing diagram 400 of announcement of P2P transmission windows by an AP according to embodiments of the present disclosure. In this example, the AP uses a Beacon frame to transmit the announcement to the BSS. In other embodiments, the AP may use a Probe Response frame to transmit the announcement.

According to one embodiment, in the announcement of P2P transmission windows, the AP can indicate one or more of: the start of the first P2P transmission window in a series of transmission windows, the duration of each P2P transmission window, the periodicity of the P2P transmission windows, the end time of the last P2P transmission window in a series of transmission windows (or a time after which there will be no more P2P transmission windows in a series of transmission windows), or the channels and operating classes that can be used for transmission during a P2P transmission window in a series of transmission windows.

According to one embodiment, an AP can indicate one or more series of P2P transmission windows—each series may have its own start time, duration, periodicity, end time, and recommended channels (and operating classes) for each P2P transmission window in that series of transmission windows.

According to one embodiment, a series of P2P transmission windows may contain one or more P2P transmission windows.

According to one embodiment, a non-AP STA in the network that receives the advertisement from the AP announcing P2P transmission windows may not be allowed to transmit its P2P traffic outside the P2P transmission windows. According to another embodiment, a non-AP STA in the network that receives the advertisement from the AP announcing P2P transmission windows can still transmit its P2P traffic outside the P2P transmission windows, but it may be more beneficial for the STA to transmit during the P2P transmission windows since the STA may encounter less interference from the infrastructure network during the P2P transmission windows.

According to one embodiment, if an AP announces a series of P2P transmission windows, then the AP may minimize interference from the infrastructure network (e.g., UL/DL transmissions) during those P2P transmission windows. For example, the AP may not transmit at all during the P2P transmission windows or the AP may not trigger non-AP STAs for uplink transmission during the P2P transmission windows. This provides an incentive for P2P STAs to use the P2P transmission windows for their P2P communications.

According to one embodiment, an AP may announce a series of P2P transmission windows and indicate a first set of channels that is recommended for use by non-AP STAs for P2P communication during the P2P transmission windows. According to one such embodiment, the AP may still transmit during the P2P transmission windows. According to another such embodiment, the AP may use a second set of channels for transmission during the P2P transmission windows.

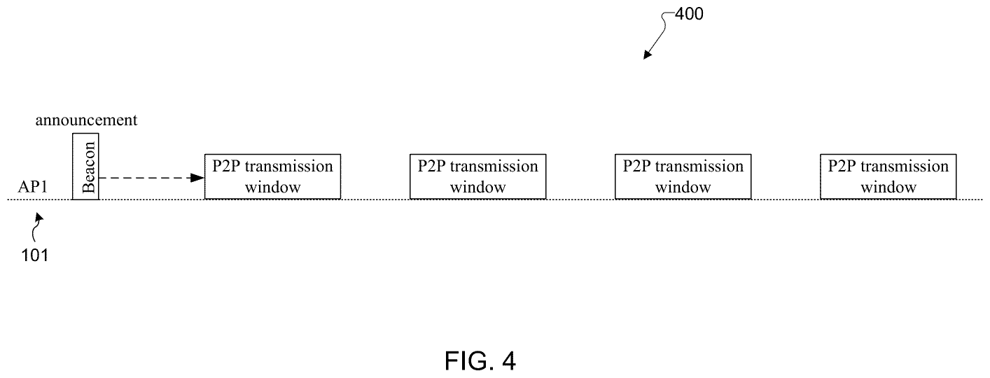

FIG. 5 illustrates an example timing diagram 500 for a scenario in which an AP indicates recommended channels for transmissions during P2P transmission windows and continues transmissions on other channels during the P2P transmission windows according to embodiments of the present disclosure. In this example, the AP recommends channel 5 for use by non-AP STAs for P2P transmissions during the indicated P2P transmission windows. The AP avoids infrastructure transmissions on channel 5 during the P2P transmission windows, but may continue to transmit on channels other than channel 5 during the P2P transmission windows.

According to one embodiment, if an AP announces a series of P2P transmission windows, then the AP may integrate a power saving schedule with the schedule of P2P transmission windows. For example, the AP may go into a power saving mode (e.g., Doze state) during the P2P transmission windows in a series of P2P transmission windows. For example, if the AP uses a TWT schedule for its power saving mode, then the TWT doze state timings of the AP can be aligned with the P2P transmission windows.

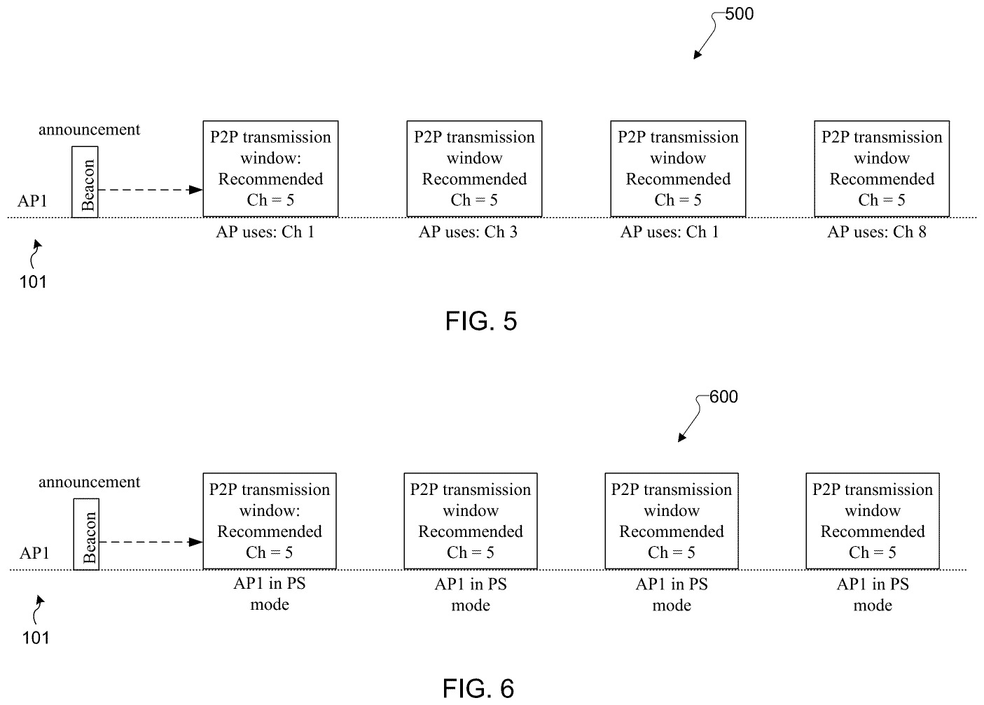

FIG. 6 illustrates an example timing diagram 600 for a scenario in which an AP aligns a power saving schedule with indicated P2P transmission windows according to embodiments of the present disclosure. As illustrated, the AP enters the power saving mode during each of the P2P transmission windows.

According to one embodiment, the right of a non-AP STA to transmit during a P2P transmission window can be based on membership. A non-AP STA, upon receiving an announcement of the P2P transmission window from an AP, may request membership in the corresponding P2P transmission window schedule. If the AP accepts the request, then the non-AP STA obtains the right to transmit during the P2P transmission windows of the schedule. In some embodiments, there can be a TWT-like negotiation for the P2P transmission window schedule—for example, the AP and non-AP STAs can accept, reject, or modify a proposed P2P transmission window schedule. Also, the advertisement and negotiation procedure for the P2P transmission window can be similar to the advertisement and negotiation of a TWT schedule.

According to various embodiments there may be different types of P2P transmission windows. In one embodiment, the AP can indicate types of P2P transmissions that are allowed for specific P2P transmission windows. For example, the AP may indicate that a first P2P transmission window is only for P2P communication, a second P2P transmission window is for P2P and UL/DL communication, a third P2P transmission window is only for tunneled direct link setup (TDLS) transmission (i.e., only for P2P transmission by the non-AP STAs that are associated with the AP), and a fourth P2P transmission window is for P2P communication by non-AP STAs that are not associated with the AP (e.g., WI-FI Direct or WI-FI Aware).

According to one embodiment, operation of non-AP STAs during the P2P transmission windows is on a triggered basis. For example, during the P2P transmission windows, the AP can trigger different P2P STAs or P2P groups to transmit during different P2P transmission windows. According to one embodiment, a non-AP STA that has a P2P requirement or that obtains membership of a schedule for a P2P transmission window may not transmit its P2P traffic until the non-AP STA is triggered by the AP for its P2P transmission.

According to one embodiment, to devise a schedule for P2P transmission windows a non-AP STA that has a P2P requirement may first indicate its P2P requirement (e.g., quality of service (QOS) requirement, P2P traffic pattern, bandwidth needed, delay bound, etc.) to an AP. These requirements can be conveyed to the AP using a QoS Characteristics element or SCS procedure. Alternatively, the non-AP STA can send a frame to the AP that would indicate a request for P2P assistance from the AP. Such a frame may also contain the corresponding P2P requirement of the STA.

The AP may collect such P2P requirements from multiple non-AP STAs, and based on the collection of P2P requirements, the AP may devise the schedule for P2P transmission windows. For example, the AP may attempt to create a schedule for P2P transmission windows that satisfies the largest possible number of non-AP STA's P2P requirements. The AP may attempt to create the schedule for P2P transmission windows to additionally align with its power saving schedule, as discussed above.

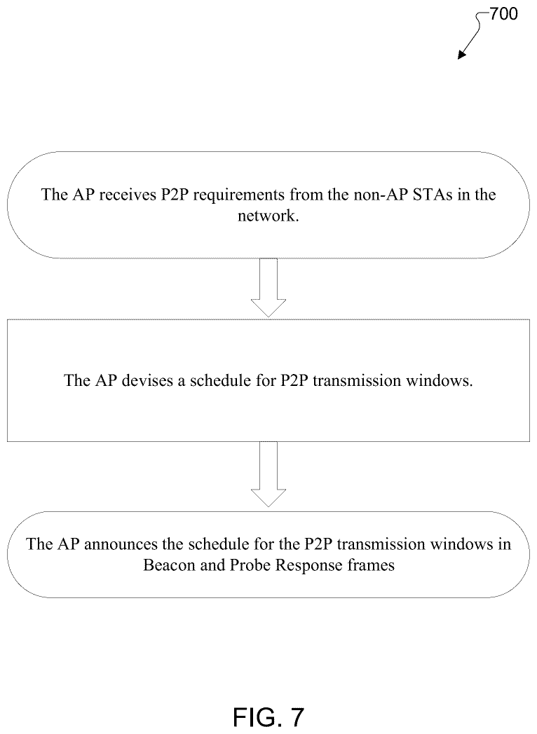

FIG. 7 illustrates an example process 700 performed by an AP to devise and announce a schedule for P2P transmission windows according to embodiments of the present disclosure.

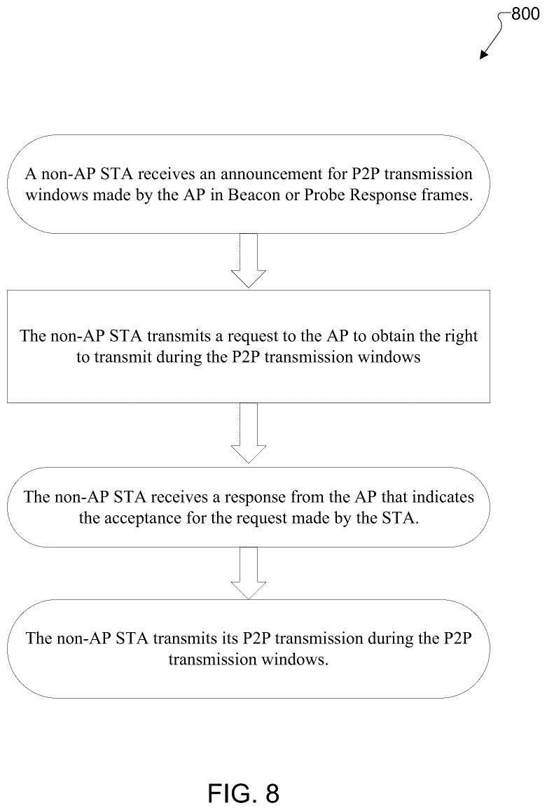

FIG. 8 illustrates an example process 800 performed by a non-AP STA to follow a schedule for P2P transmission windows according to embodiments of the present disclosure.

The embodiments described herein above can also be extended for multi-AP coordination.

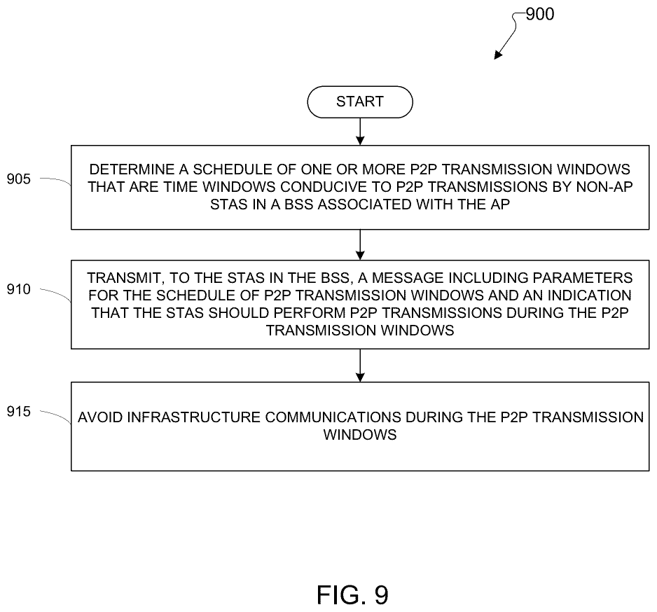

FIG. 9 illustrates an example process 900 for facilitating establishment and use of a time window that is conducive to transmission of unmanaged traffic operations in a WLAN according to various embodiments of the present disclosure. The process 900 of FIG. 9 is discussed as being performed by an AP, but it is understood that corresponding STAs operating in the AP's BSS perform a corresponding process. Additionally, for convenience the process of FIG. 9 is discussed as being performed by a WI-FI AP, however, it is understood that any suitable wireless communication device could perform this process.

Referring to FIG. 9, at step 905 the AP determines a schedule of one or more P2P transmission windows that are time windows conducive to P2P transmissions by non-AP STAs in a BSS associated with the AP. In some embodiments the AP receives, from at least some of the STAs, P2P transmission requirements before step 905. and then at step 905 the AP determines the schedule based on the received P2P transmission requirements (e.g., to fulfill as many of the P2P transmission requirements as possible). Such P2P transmission requirements may include at least one of a QoS requirement, a P2P traffic pattern, a bandwidth requirement, and a delay bound.

Next the AP transmits, to the STAs in the BSS, a message including parameters for the schedule of P2P transmission windows and an indication that the STAs should perform P2P transmissions during the P2P transmission windows (step 910). The parameters may include one or more of a start time of a first P2P transmission window in the schedule, a duration of each P2P transmission window in the schedule, a periodicity of the P2P transmission windows in the schedule, an end time of a last P2P transmission window in the schedule, and one or more recommended channels for P2P transmissions during the P2P transmission windows.

In some embodiments the parameters for the schedule are determined such that the P2P transmission windows coincide with time windows during which the AP is scheduled to enter a power saving mode.

In some embodiments the message further includes an indication that the STAs are not allowed to perform P2P transmissions outside of the P2P transmission windows.

Finally, the AP avoids infrastructure communications during the P2P transmission windows (step 915). In cases in which the parameters include one or more recommended channels for P2P transmissions during the P2P transmission windows, the AP here avoids the infrastructure communications on the recommended channels during the P2P transmission windows.

In some embodiments the AP may additionally determine a set of the STAs to perform P2P transmissions for a P2P transmission window, and then trigger to the determined set of STAs to perform P2P transmissions during the P2P transmission window.

in some embodiments the AP may additionally determine at least some of the STAs to be member STAs of the schedule. In such embodiments, the member STAs are allowed to perform P2P transmissions during the P2P transmission windows and non-member STAs are not allowed to perform P2P transmissions during the P2P transmission windows.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by an access point (AP) wireless device, the method comprising:
determining a schedule of one or more peer-to-peer (P2P) transmission windows that are time windows conducive to P2P transmissions by non-AP stations (STAs) in a basic service set (BSS) associated with the AP;
transmitting, to the STAs in the BSS, a message including parameters for the schedule of P2P transmission windows and an indication that the STAs should perform P2P transmissions during the P2P transmission windows; and
avoiding infrastructure communications during the P2P transmission windows.

2. The method of claim 1, wherein the parameters include one or more of:
a start time of a first P2P transmission window in the schedule,
a duration of each P2P transmission window in the schedule,
a periodicity of the P2P transmission windows in the schedule,
an end time of a last P2P transmission window in the schedule, and
one or more recommended channels for P2P transmissions during the P2P transmission windows.

3. The method of claim 1, wherein:
the parameters include one or more recommended channels for P2P transmissions during the P2P transmission windows, and
the method comprises avoiding the infrastructure communications on the recommended channels during the P2P transmission windows.

4. The method of claim 1, wherein the message further includes an indication that the STAs are not allowed to perform P2P transmissions outside of the P2P transmission windows.

5. The method of claim 1, wherein determining the schedule comprises determining the parameters for the schedule such that the P2P transmission windows coincide with time windows during which the AP is scheduled to enter a power saving mode.

6. The method of claim 1, further comprising:
determining a set of the STAs to perform P2P transmissions for a P2P transmission window; and
triggering to the determined set of STAs to perform P2P transmissions during the P2P transmission window.

7. The method of claim 1, further comprising:
receiving, from at least some of the STAs, P2P transmission requirements; and
determining the schedule based on the received P2P transmission requirements.

8. The method of claim 7, wherein determining the schedule comprises determining the schedule to fulfill as many of the P2P transmission requirements as possible.

9. The method of claim 7, wherein the P2P transmission requirements include at least one of:
a quality of service (QOS) requirement,
a P2P traffic pattern,
a bandwidth requirement, and
a delay bound.

10. The method of claim 1, further comprising:
determining at least some of the STAs to be member STAs of the schedule,
wherein the member STAs are allowed to perform P2P transmissions during the P2P transmission windows and non-member STAs are not allowed to perform P2P transmissions during the P2P transmission windows.

11. A method performed by a non-access point station (STA) wireless device, the method comprising:
receiving, from an access point (AP) in a basic service set (BSS) with which the STA is associated, a message including parameters for a schedule of peer-to-peer (P2P) transmission windows and an indication that the STA should perform P2P transmissions during the P2P transmission windows, wherein the AP avoids infrastructure communications during the P2P transmission windows; and
performing P2P transmissions during the indicated P2P transmission windows.

12. The method of claim 11, wherein the parameters include one or more of:
a start time of a first P2P transmission window in the schedule,
a duration of each P2P transmission window in the schedule,
a periodicity of the P2P transmission windows in the schedule,
an end time of a last P2P transmission window in the schedule, and
one or more recommended channels for P2P transmissions during the P2P transmission windows.

13. The method of claim 11, wherein:
the parameters include one or more recommended channels for P2P transmissions during the P2P transmission windows, and
the AP avoids the infrastructure communications on the recommended channels during the P2P transmission windows.

14. The method of claim 11, wherein the message further includes an indication that the STA is not allowed to perform P2P transmissions outside of the P2P transmission windows.

15. The method of claim 11, wherein the P2P transmission windows coincide with time windows during which the AP is scheduled to enter a power saving mode.

16. The method of claim 11, further comprising receiving, from the AP, a trigger to perform P2P transmissions during the P2P transmission window.

17. The method of claim 11, further comprising:
transmitting, to the AP, P2P transmission requirements,
wherein the schedule is determined based on the P2P transmission requirements and P2P transmission requirements received by the AP from other STAs in the BSS.

18. The method of claim 17, wherein the schedule is determined to fulfill as many of the P2P transmission requirements as possible.

19. The method of claim 17, wherein the P2P transmission requirements include at least one of:
a quality of service (QOS) requirement,
a P2P traffic pattern,
a bandwidth requirement, and
a delay bound.

20. The method of claim 11, wherein:
the STA is determined to be a member STA of the schedule, and
member STAs of the schedule are allowed to perform P2P transmissions during the P2P transmission windows and non-member STAs are not allowed to perform P2P transmissions during the P2P transmission windows.
